(19) United States
(12) Patent Application Publication
(10) Pub. No.: US 2012/0009018 A1
(43) Pub. Date: Jan. 12, 2012

(54) CULVERT LINER

(75) Inventors: Jacob J. Marquis, Glenburn, ME (US); Alexander J. Thibodeau, Turner, ME (US)

(73) Assignees: KENWAY CORPORATION, Augusta, ME (US); UNIVERSITY OF MAINE SYSTEM BOARD OF TRUSTEES, Bangor, ME (US)

(21) Appl. No.: 13/180,935

(22) Filed: Jul. 12, 2011

Related U.S. Application Data
(60) Provisional application No. 61/363,312, filed on Jul. 12, 2010.

(51) Int. Cl. E02B 8/08; F16L 55/18

(52) U.S. Cl. 405/81; 405/184.2

(57) ABSTRACT

A liner for repairing a culvert includes a substantially semi-cylindrical body having an inside surface and an outside surface. The liner is configured for attachment to an inside surface of a culvert and has a shape corresponding to the inside surface of the culvert.

### CROSS REFERENCE TO RELATED APPLICATIONS

This application claims the benefit of U.S. Provisional Application No. 61/363,312 filed Jul. 12, 2010.

### BACKGROUND OF THE INVENTION

Various embodiments of a culvert liner are described herein. In particular, the embodiments described herein relate to an improved liner for repairing and extending the life of large diameter drainage culverts.

Culverts are enclosed conduits used to direct rainwater run-off or natural waterways typically under traffic paths such as roads or pedestrian crossings. Common culvert materials include concrete, masonry, plastic polymer, and metal. These materials are relatively robust and provide reasonable durability despite being buried under soil, concrete, asphalt, tarmac, and the like.

Culverts situated in harsh environments are generally expected to have shorter service lives than culverts in relatively less harsh environments. When installed under a road, load bearing ratings must be observed to prevent culverts from becoming overloaded and collapsing. Culvert longevity is known to be diminished by site specific environmental conditions unique to the location of the culvert, rather than by forces causing structural stress. Factors such as the abrasiveness, pH, and electrical conductivity of fluid flowing through the culvert, and the related characteristics of the surrounding soil are understood to be determinative of culvert longevity.

Abrasion occurs as culvert material is eroded away by contact with bedload. As used in the description of the invention and the appended claims, the word “bedload” is defined as particles in the fluid flowing through the culvert. For any given culvert material, the rate of abrasion is determined by the physical characteristics, frequency, velocity, and quantity of the bedload in the culvert flow. Special linings may be used to extend the service life of culverts expected to be exposed to significantly abrasive bedload. For example, concrete or bituminous linings may be attached along the bottom section or “invert” of newly installed culverts to minimize abrasion. As an added measure of protection, debris control structures such as grates or screens may be used to reduce the amount of bedload that contacts the inside surface of the culvert. Such features however, add to the cost of construction, cleaning, and maintenance throughout the service life of the culvert.

Corrosion occurs as culvert material is worn away or displaced because of chemical or electrochemical reactions with environmental elements. Corrosion is a problem for most culvert materials, although metal is particularly vulnerable. Acidic and alkaline conditions, saltwater, and high electrical conductivity in the culvert flow and surrounding soil significantly worsen corrosion. Metal culverts may be treated or coated with zinc or aluminum to resist corrosion. Steel culverts are often galvanized but are generally understood to be subject to corrosion if placed in soil or water where the pH level is outside the range of about 6 to about 10.

Many culverts in operation today are made from metal. Culverts with relatively smaller diameters are often formed from lengths of pipe that may or may not be corrugated for strength. Larger diameter metal culverts may also be made of metal, but are typically assembled from pre-manufactured corrugated sheets or plates that are bolted together on site, and then attached to frames and/or braced to improve their load bearing capacity.

Culverts are a commonly used alternative to building bridges over streams and other natural waterways used by migrating fish. Culverts may therefore also be designed to allow fish to move through the culvert as they navigate up and downstream. In culverts in which a fish ladder or weir is provided, the slope of the culvert should be approximately equal to that of the stream bed. Culverts with slopes steeper than the stream bed may create shallow or high velocity flows that are impassable by fish. Ideally, a culvert is positioned within the bed of the waterway so that the inlet and outlet inverts will be below the surface of the flow as it is expected to occur during fish spawning season.

Culverts employed in natural waterways must also be sized to provide an adequate rate of flow. Several smaller culverts may be installed adjacent one another, or a single large culvert may be used for a given waterway. While smaller culverts are less burdensome to handle, large culverts are more easily kept free of debris and are better suited for applications where fish passing through the culvert is a concern. For this reason, culverts that enclose natural waterways frequently have diameters of four feet or more.

It is widely recognized that a significant proportion of large culverts in service today have exceeded their service lives and are in need of repair or replacement. Replacing existing culverts is relatively expensive due the cost of material, labor, and heavy equipment needed. Additionally, when a culvert is replaced, traffic that may otherwise use the roadway above the culvert must be diverted for long periods of time while the culvert is replaced and the roadway is repaired.

In view of the expense and inconvenience of completely replacing a culvert, methods have been devised to rehabilitate damaged and corroded culverts in-situ. These methods are designed to restore culvert continuity and integrity without significantly diminishing fluid flow. Typical methods of in-situ culvert rehabilitation include: (1) expanding and hardening a temperature sensitive PVC liner inside the culvert with steam and compressed air; (2) winding an interlocking spiral PVC strip inside the culvert to form a continuous liner; (3) applying a reinforced or unreinforced spray-on cement mortar lining; (4) closely fitting an inverted resin impregnated fabric liner, also known as a cured in place pipe (CIPP); and (5) using grout to attach a smaller diameter conduit, usually made of thermoplastic polymer material, also known as sliplining. These culvert rehabilitation methods vary in the amount of cross sectional surface that may be sacrificed, and in the amount of culvert fluid flow that must be temporarily diverted to perform the repair. An advantage of these in-situ rehabilitation methods relative to complete culvert replacement is that in-situ rehabilitation can often be performed without re-routing traffic.

Because much, if not all, excavation expenses are avoided, current in-situ rehabilitation methods may be used to restore culverts a significantly lower cost than complete culvert replacement. However, although lower than complete culvert replacement, the cost of current in-situ rehabilitation methods remain significant, particularly in circumstances requiring specialized machinery, and requiring labor at the job site for extended periods of time.

Further, current in-situ rehabilitation methods are often complex and present several distinct disadvantages. Unreinforced cement or concrete spray-on coatings may be applied relatively easily, but are typically thin and do little to improve structural integrity. Coatings that include reinforcement material require specialized equipment and labor to apply, and may significantly decrease culvert flow. The CIPP method involves multiple steps along with swift, concerted action at the jobsite. The resin impregnated fabric liner typically must be refrigerated prior to installation, and toxic styrene materials used for curing the liner may contaminate fluid flowing through the culvert. The smaller diameter conduits of the sliplining method are relatively less complicated to install, but the conduits are typically rigid liners that may be difficult to pass through misaligned culverts without significantly reducing conduit diameter. Slip liners used in large diameter culverts are typically not lightweight or compact, and thus require the use of heavy equipment for transport and installation.

Other methods of repairing damaged culverts exist in the art but are not widely used or definitively proven. For example, U.S. Pat. No. 5,351,720 to Maimets describes an internal conduit repair method that comprises a rolled sleeve member and gaskets. The disclosed apparatus has the advantage of being transportable as a flat sheet but is without fastener connections and thus it relies only on a grouted connection to transfer forces from the damaged culvert.

While less costly than complete culvert replacement, the significant cost of in-situ rehabilitation methods continues to discourage municipalities from undertaking culvert restoration. Delayed repairs may lead to an amount of culvert deterioration that exceeds the capacity of in-situ rehabilitation and repair methods. The above notwithstanding, there remains a need in the art for an easy and more economical culvert rehabilitation system that may be used in small and large diameter culverts, and that provides a dependable and long lasting repair.

### SUMMARY OF THE INVENTION

The present application describes various embodiments of a liner for repairing a culvert. One embodiment of the liner for repairing a culvert includes a substantially semi-cylindrical body having an inside surface and an outside surface. The liner is configured for attachment to an inside surface of a culvert and has a shape corresponding to the inside surface of the culvert.

In another embodiment, a culvert liner system for repairing a culvert includes a culvert having an inside surface. A culvert liner is mounted to the inside surface of the culvert and defines a semi-annular space between an outside surface of the culvert liner and the inside surface of the culvert. A layer of grout is disposed within the semi-annular space.

In an additional embodiment, a method of repairing a culvert includes positioning a culvert liner within a culvert such that the culvert liner is spaced apart from the culvert to define a semi-annular space between an outside surface of the culvert liner and the inside surface of the culvert. A portion of the culvert liner is attached to the culvert with fasteners, and the semi-annular space is filled with grout.

Other advantages of the liner for repairing a culvert will become apparent to those skilled in the art from the following detailed description, when read in light of the accompanying drawings.

### BRIEF DESCRIPTION OF THE DRAWINGS

FIG. 1 is a perspective view of a first embodiment of a culvert liner according to the invention.

FIG. 2 is a perspective view, partially cut away, of a first embodiment of a typical culvert.

FIG. 2A is an enlarged perspective view of a portion of the culvert illustrated in FIG. 2.

FIG. 3 is a cross sectional end view of a first embodiment of a culvert liner system according to the invention, showing the culvert liner illustrated in FIG. 1 installed in the culvert illustrated in FIG. 2.

FIG. 3A is an enlarged cross sectional view of a portion of the culvert liner system illustrated in FIG. 3.

FIG. 4 is an exploded schematic view of a first embodiment of a method of forming a culvert liner according to the invention.

FIG. 5 is a perspective view, partially cut away, of a second embodiment of a culvert liner system, showing a second embodiment of the culvert liner installed in a second embodiment of the culvert.

FIG. 6 is a perspective view, partially cut away, of a third embodiment a culvert, showing furring strips according to the invention.

FIG. 7 is a cross sectional end view of a third embodiment of a culvert liner system according to the invention, showing a third embodiment of the culvert installed in the culvert illustrated in FIG. 6.

FIG. 7A is an enlarged cross sectional view of a portion of the culvert liner system illustrated in FIG. 7.

FIG. 8 is a perspective view of a fish weir.

FIG. 9 is a perspective view, partially cut away, of a plurality of the fish weirs mounted to the culvert liner illustrated in FIG. 1, and installed in the culvert illustrated in FIG. 2.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The culvert liner of the invention allows damaged or corroded culverts or drain pipes to be repaired in-situ. According to the present invention, a culvert rehabilitation system is provided that restores structural integrity and thus improves culvert load bearing ability while maintaining fluid flow through the culvert. The system incorporates a culvert liner that is fastened and cemented in place. Once installed, the culvert liner has a relatively low profile and in most cases does not raise the inner surface of the culvert more than one inch. Advantageously, the fluid flow characteristics, and ease of fish passage, through the culvert are not significantly hampered.

The culvert liner system comprises one or more relatively thin, semi-cylindrical culvert liners. Each panel is attached to the culvert using penetrating fasteners that stabilize the panel and transfer compressive forces from the upper portion of the culvert to the liner. Depending upon the magnitude of forces that the liner must bear, the panels may be made from a variety of materials including but not limited to fiber reinforced composite, metal, or plastic polymer. In the embodiments described herein, the panels are abrasion and corrosion resistant so as to extend the service life of the liner.

Culver liners of the invention are preferably prefabricated in a controlled environment, thereby reducing the amount of time in the field and improving quality control. In an exemplary embodiment, a panel is made from E-glass fiber-reinforced composite material that is lightweight and strong. The culvert liners have a relatively thin profile and are sized with a radius to be closely fitted to the invert flow surface of a damaged culvert. Each culvert liner comprises two designated nailing areas along each upper side through which penetrating fasteners are installed. The elevated location of the nailing area ensures that the fasteners are more likely to be inserted into sound material of the host culvert to secure the panel. In the illustrated embodiments, the fasteners are abrasion and corrosion resistant, although given their location they should seldom be immersed in culvert flow.

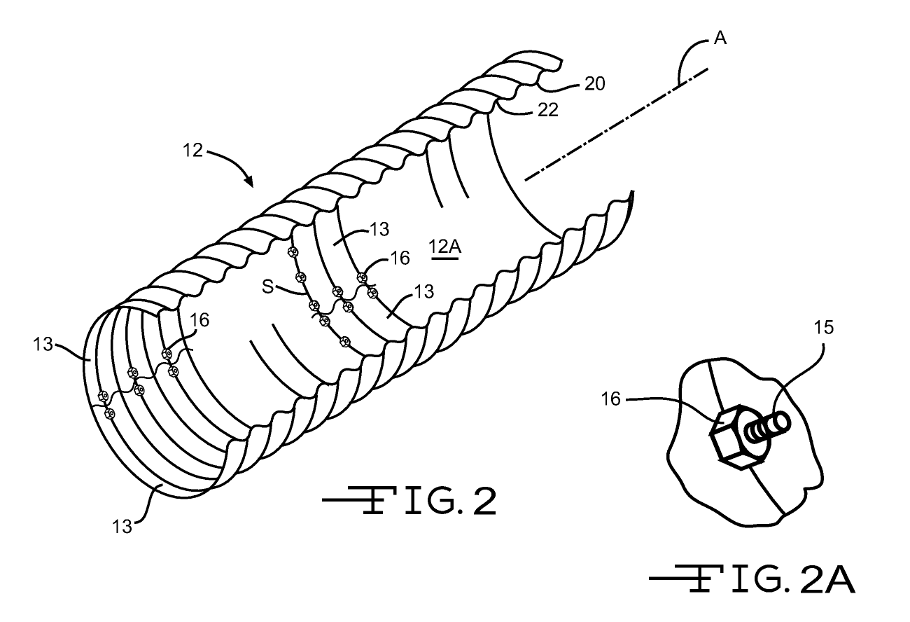

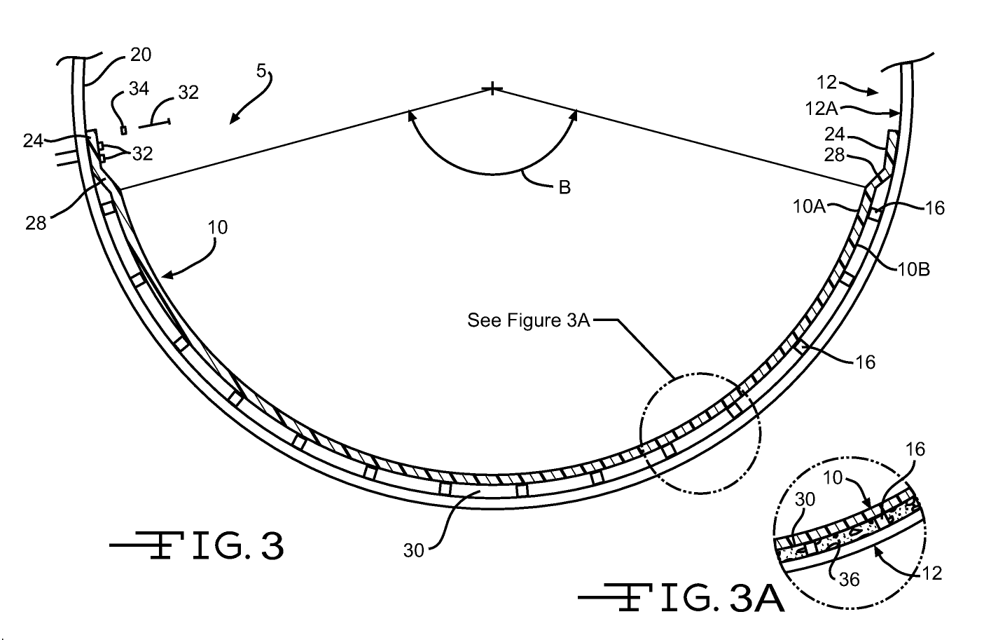

Referring now to FIG. 3, a first embodiment of a culvert liner system is shown at 5. The culver liner system 5 includes a first embodiment of a culvert liner 10 installed in a culvert 12. The illustrated culvert 12, also shown in FIG. 2, is a corrugated culvert having a longitudinal axis A. The inside surface 12A of the culvert 12 includes a plurality of circumferentially extending, parallel, and alternating ridges 20 and furrows 22.

As best shown in FIG. 2, the culvert 12 may include a plurality of semi-cylindrical portions or plates 13 attached together by fasteners, such as bolts 15 and nuts 16, best shown in FIG. 2A. Typically, the nuts 16 and/or the bolts 15 extend outward of the inside surface 12A of the culvert 12 a distance within the range of from about 1.0 inch to about 1.5 inches. In the embodiment shown in FIGS. 2 and 3, only the nuts 16 are visible.

Circumferentially, such as at the seam S shown in FIG. 2, the bolts 15 and nuts 16 are spaced apart about 12.0 inches. Alternatively, the bolts 15 and nuts 16 may be spaced apart any other desired distance, such as within the range of from about 6.0 inches to about 18.0.

The illustrated culvert 12 is configured for deployment in a streambed substantially horizontally, or where the axis A of the culvert 12 is substantially parallel with the streambed. Alternatively, if necessary to ensure fluid flow through the culvert 12, the culvert 12 may be deployed such that the axis A is at an angle relative to the streambed.

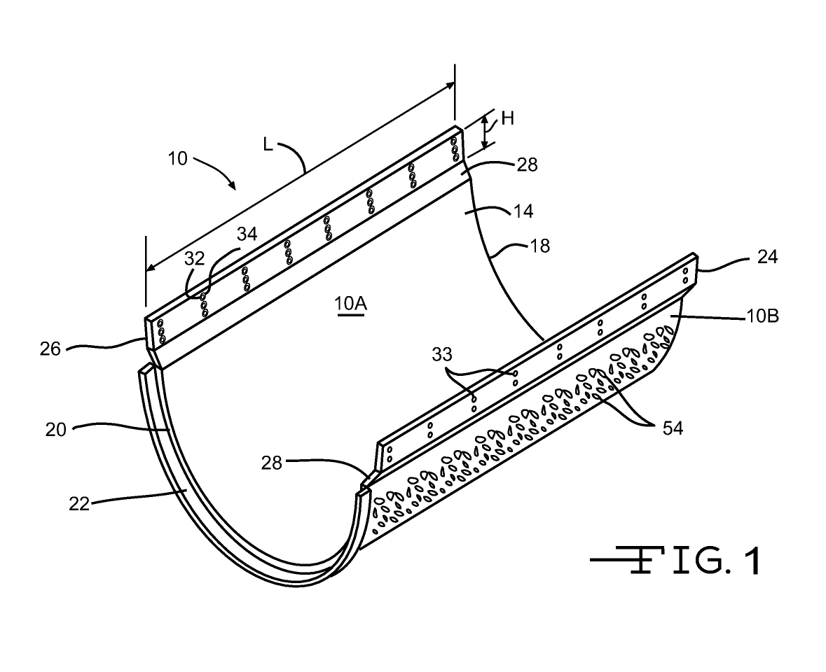

As best shown in FIG. 1, the culvert liner 10 includes a body 14 having a substantially semi-cylindrical shape, an inside surface or flow face 10A, a second or outside surface 10B, a first axial end 18, a second axial end 20 opposite the first end, a first axially extending edge area 24, a second axially extending edge area 26, and a length L. The first and second axially extending areas 24 and 26 have a height H. The outside surface 10B has a substantially uniform radius substantially corresponding to the radius of the inside surface 12A of the culvert 12. Angled, axially extending transition areas 28 are formed between the first and second axially extending edge areas 24 and 26 and the semi-cylindrical body 14. In the illustrated embodiment, the first and second axially extending edge areas 24 and 26 define nailing flanges, through which fasteners, such as nails, will be driven or inserted.

In the illustrated embodiment, the length L of the culvert liner 10 is about 10 feet. Alternatively, the culvert liner 10 may have a length within the range of from about 8 feet to about 12 feet. Additionally, the culvert liner 10 may have a length within the range of from about 4 feet to about 20 feet. The culvert liner 10 may also have a length less than about 4 feet or greater than about 20 feet. In the illustrated embodiment, the height H of the first and second axially extending areas 24 and 26 is about 6 inches. Alternatively, the first and second axially extending areas 24 and 26 may have any other desired height determined by the number of rows of fasteners 32 needed to secure the culvert liner 10 to the culvert 12.

As best shown in FIG. 3, the illustrated culvert liner 10 extends through an arc B of about 150 degrees centered on a bottom section or invert of the culvert 12. Alternatively, the arc B may be within the range of from about 140 degrees to about 160 degrees. Additionally, the arc B may be within the range of from about 90 degrees to about 180 degrees. The arc B may also be less than about 90 degrees or greater than about 180 degrees.

An underbite flange 22 extends longitudinally outward of the second end 20 (to the left when viewing FIG. 1). When a plurality of the culvert liners 10 are used in a culvert 12, the underbite flange 22 extends underneath the first or plain axial end 18 of an adjacent culvert liner 10. The underbite flange 22 may extend outward of the second axial end 20 any desired distance, such as a distance of about 3.0 inches. Alternatively, the underbite flange 22 may extend outward of the second axial end 20 a distance within the range of from about 1.0 inch to about 5.0 inches. The underbite flange 22 may also extend outward of the second axial end 20 a distance less than about 1.0 inch or greater than about 5.0 inches.

The underbite flange 22 further has a radius slightly larger than the radius of the flow face 10A of the culvert liner 10. Alternatively, the flange 22 may be formed such that it has a radius slightly smaller than the radius of the flow face 10A of the culvert liner 10. This embodiment of the flange 22 would then extend over, rather than underneath, the first or plain axial end 18 of an adjacent culvert liner 10.

The underbite flange 22 may be bonded to the first axial end 18 of an adjacent culvert liner 10 by any desired method, such as with caulk, grout, or an adhesive such as a methacrylate adhesive.

Regardless of the type of culvert being repaired, the culvert 12, should be cleaned of sediment and debris before attaching the culvert liners 10. For example, for culverts 12 assembled from multiple corrugated plates 13, as shown in FIG. 2, culvert assembly bolts located in a region of the culvert 12 that will be covered by the culvert liner 10 should be cut or trimmed if they extend more than about half an inch beyond the nuts 16. Further, if there is a possibility that the stability or load bearing capacity of the culvert 12 may be compromised during repair, adequate bracing, or other means of support may be used to prevent deformation or collapse of the culvert 12.

To prepare the culvert for in-situ rehabilitation according to the invention, the stream flow must be first stopped or diverted around the damaged culvert. Commercially available drainage pumps and high volume hoses may be used. In a typical culvert with at least some fluid running through the culvert, the drainage pump must be run during the culvert liner 10 installation process to keep the inlet and outlet areas of the culvert relatively dry.

The culvert 12 may be prepared by first cleaning away sediment and corroded material. An inside surface of the culvert 12 may be cleaned with water, such as with a pressurized water stream. Culvert assembly bolts extending outward of the nuts 16 in a region of the culvert 12 that will be covered by the culvert liner 10 may then be cut or trimmed as described above.

Lights may be provided inside the culvert 12. Each culvert liner 10 to be installed may be positioned within the culvert 12 in the location where it will be fastened. If the culvert liner 10 does not fit within the culvert 12 such that the nailing flanges 24 and 26 close to or touching the inside surface 12A of the culvert 12, a force may be applied to the culvert liner 10 to urge the nailing flanges 24 and 26 into contact with the inside surface 12A of the culvert 12. This force may be applied by any desired means, such as with a telescoping pole, or a length of lumber, such as a 2×4, and a wedge.

The culvert liners 10 may then be fastened to the inside surface of the culvert 12 using a nail driver. One example of a suitable nail driver is a powder actuated nail driver manufactured by Hilti, Inc., with headquarters in Tulsa, Okla.

Fasteners 32 are inserted through the nailing flanges 24 and 26. In one embodiment, as shown at the nailing flange 26 in FIG. 1, the fasteners 32 are organized in three rows spaced about 2 inches apart, and vertically aligned and longitudinally spaced about 6 inches apart, so as to be inserted through the ridges 20 of the culvert 12, as shown in FIG. 1. In the illustrated embodiments, the ridges 20 are spaced 6 inches apart. Alternatively, the fasteners 32 are organized in any desired number of rows, or any other desired pattern, and longitudinally spaced any desired distance apart to correspond with the ridges of the culvert being repaired. It will be understood that the number of rows of fasteners 32 will be determined by the desired seam strength between the nailing flanges 24 and 26 and the inside surface 12A of the culvert 12.

In the illustrated embodiment, the fasteners 32 are penetrating mechanical fasteners. In one embodiment, the fasteners 32 are powder driven nails. Alternatively, the fasteners 32 may be screws, bolts, pins, or rivets. Additionally, any other penetrating fasteners that have sufficient holding power and strength, and that provide adequate resistance to degradation from environmental factors, may be used to attach the culvert liner 10 to the culvert 12. The chosen fasteners must be long enough to penetrate the culvert liner 10 and penetrate into or beyond the culvert 12.

Washers 34 may be installed between the fasteners 32 and the nailing flanges 24 and 26 to help maintain fastener tension, distribute the pressure of the fasteners 32 evenly over the culvert liner 10, and to provide a bearing surface for the fastener heads. In an alternate embodiment of the present invention, as shown at the nailing flange 24 in FIG. 1, the culvert liner 10 may be manufactured with fastener holes 33 evenly spaced along the nailing flange. The fastener holes 33 provide convenient references for positioning the fasteners 32 before driving them through the culvert liner 10 and the culvert 12. Alternatively, any desired number of holes 33 may be formed in the culvert liner 10 and spaced in any even or uneven pattern at any desired distance apart.

Caulk may be applied between the overlapping first axial end 18 and the underbite flange 22 of an adjacent and previously fastened culvert liner 10. This process may continue for each successive culvert liner 10 installed within the culvert 12.

As shown in FIG. 3, one or more of the culvert liners 10 may be disposed in the culvert 12, such that the outside surface 10B of the culvert liner 10 rests on, or is disposed near, the nuts 16. Because the culvert liner 10 is spaced apart from the ridges 20 by at least the thickness of the nuts 16, a semi-annular space 30 is defined between the inside surface 12A of the culvert 12 and the outside surface 10B of the culvert liner 10. As used in the description of the invention and the appended claims, the phrase “semi-annular space” is defined as a space having the shape of a partial or incomplete annulus or ring.

After the desired number of culvert liners 10 are fastened to the culvert 12, and caulk is applied between adjacent culvert liners 10, grout 36 may be applied in the annular space 30 defined between the inside surface 12A of the culvert 12 and the outside surface 10B of the culvert liner 10. The grout 36 may be applied in the annular space 30 by pouring, injecting, or pumping a volume of low viscosity grout 36 into the annular space 30, as best shown in FIG. 3A. The grout 36 defines a grout layer that fills the annular space 30 and the furrows 22. The grout 36 thus forms a bed on which the culvert liner 10 is seated. The grout bed assists the fasteners 32 in securing the culvert liner 10 to the culvert 12, and distributes compressive forces to the culvert 12 and to the streambed below the culvert 12. In the illustrated embodiments of the invention, the grout 36 is a general purpose, high strength, non-shrink construction grout with a minimum of 5,000 PSI compressive strength at 28 days when mixed at a flowable consistency. The grout 36 may use sand as an aggregate, however the sand particles should not be larger than ⅛ inch. The grout 36 may be applied beginning with the lowermost furrow 22 of the culvert 12 and continuing in an upstream direction until grout 36 fills the entire annular space 30.

The culvert liner 10 is formed of any light weight, non-corrosive material that is rigid enough to help sustain compressive forces exerted on the culvert 12 by the surrounding soil and traffic traveling over the culvert 12.

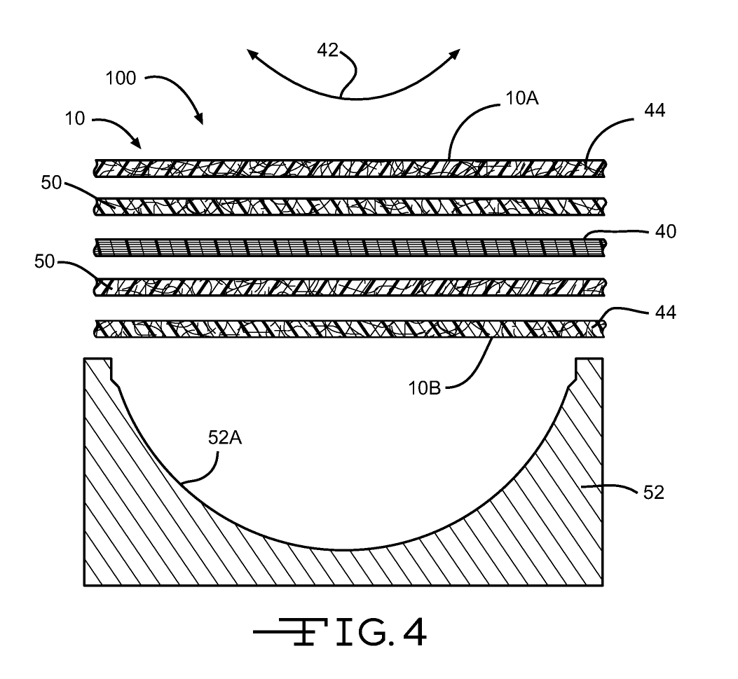

Referring now to FIG. 4, a first embodiment of a method of forming the culvert liner 10 as a composite panel is shown generally at 100. As shown in FIG. 4, fibers used to reinforce the culvert liner 10 are arranged in five layers, each of which provides specific functional characteristics to the culvert liner 10. It will be understood that the layers 40, 44, and 50 are shown in exaggerated thickness for clarity. Although the culvert liner 10 is shown being formed from five layers of material, the culvert liner 10 may also be formed from any desired number of layers of material, including less than five layers and more than five layers.

A core layer 40 comprises parallel structural fibers that will be oriented substantially in the hoop direction, indicated by the arrow 42, of the culvert liner 10 when formed. In the finished culver liner 10, the parallel fibers of the core layer 40 resist compressive stress transferred to the culvert liner 10 from the culvert 12.

Robust abrasion layers 44 define the flow face 10A and the outside surface 10B of the culvert liner 10. In the illustrated embodiment, the abrasion layers 44 comprise continuous glass fiber mats impregnated in a resin matrix. In the illustrated embodiment, the abrasion layers 44 are resin rich relative to the remainder of the culvert liner 10. Advantageously, the abrasion layer 44 that defines the flow face 10A of the culvert liner 10 presents a resin rich and robust wear surface to abrasive elements encountered by the culvert liner 10 once it is placed in operation. For example, the flow face 10A formed as described above, is significantly more resistant to damage from bedload in the fluid flowing through the culvert 12 than the inside surface 12A of a typical culvert 12.

Between the core layer 40 and the abrasion layers 44 are intermediate layers 50 of double-bias glass fiber fabric. The intermediate layers 50 improve structural integrity and increase rigidity of the culvert liner 10. As used in the description of the invention and the appended claims, the term “double-bias” is defined as a reinforcement material having two layers of fiber mat, wherein one layer is formed having fibers that lie substantially in a +45 degree orientation and the other layer is formed having fibers that lie substantially in a −45 degree orientation.

Adequate strength, such as but not limited to a compressive strength within the range of from about 60 ksi to about 70 ksi, may be achieved in a relatively thin composite culvert liner 10, for example in a culvert liner 10 having a minimum thickness of about 0.25 inches, to provide impact resistance and toughness under all handling and operational conditions. Alternatively, the culvert liner 10 may have a thickness within the range of from about 0.125 inches to about 0.50 inches. The culvert liner 10 may also have a thickness less than about 0.125 inches or greater than about 0.50 inches.

In the illustrated embodiment, the fibers used to form each of the layers 40, 44, and 50 are E-glass fibers. Alternatively, the layers 40, 44, and 50 may include fibers formed from S-glass, polypropylene, boron, carbon, and aramid and para-aramid material.

The layers 40, 44, and 50 of the culvert liner 10 may be urged together against a mold surface 52A of a mold 52 having a shape corresponding to the desired shape of the culvert 12 in which the culvert liner 10 will be used. The illustrated mold 52 has a concave mold surface 52A. Alternatively, a mold having a convex mold surface may also be used to form the culvert liner of the invention.

In the illustrated embodiment, each of the layers 40, 44, and 50 are impregnated with resin and remain in contact with the mold surface 52A until the culvert liner 12 panel is cured. In the illustrated embodiment, vinylester resin is used. Alternatively, other polymer resins, such as a polyester-vinylester resin blend, and polyester resin may also be used.

The composite culvert liner 10 described above may be formed using vacuum assisted resin transfer molding (VARTM). Alternatively, the composite culvert liner 10 may be formed using other desired open and closed molding processes. Additionally, the culvert liner 10 may be formed using processes such as extrusion, molding, or rolling, and formed from polymers, metal, and other materials that provide the desired abrasion and corrosion resistance and are strong and sturdy enough to endure the expected load stresses on the culvert liner without failure. For example, depending on the depth of the culvert, the culvert liner may experience stress from live loads (e.g., from traffic) and dead loads (e.g., from the culvert, roadway, and the surrounding soil).

If desired, the cured flow face 10A may be coated with a layer of pigmented gelcoat to provide protection against UV light that may cause fiber bloom, and to add additional abrasion resistance to the flow face 10A. As used in the description of the invention and the appended claims, the phrase “pigmented gelcoat” is defined as a polymer resin with pigment configured to improve impact and crack resistance, and to produce a tough, resilient film on the surface to which it is applied.

If further desired, aggregate material 54 may be bonded to the outside surface 10B of the culvert liner 10, as shown in FIG. 1. Advantageously, the aggregate material 54 improves the connection between the culvert liner 10 and the layer of grout 36. The aggregate material 54 may be bonded to the culvert liner 10 by first applying a film or layer of resin impregnated fiber mat to the outside surface 10B of the cured culvert liner 10 and then applying the aggregate material 54 to the layer of resin impregnated fiber mat. In the illustrated embodiment, the aggregate material is crushed granite. Alternatively, the aggregate material 54 may include any crushed stone having substantially sharp, jagged edges to facilitate bonding with the layer of grout 36. The aggregate material 54 may be crushed such that the granules have a size within the range of from about 0.125 inches to about 0.25 inches. Alternatively, the granules may have a size within the range of from about 0.0625 inches to about 0.375 inches.

The fiber mat may be a non-woven such as a 1.5 ounce chopped strand mat. Alternatively, any desired woven and non-woven mats may be used. The resin may be vinylester resin, or any of the resins identified above. Advantageously, the aggregate material 54 improves the connection between the culvert liner 10 and the layer of grout 36.

Advantageously, the culvert liners of the invention may be produced in a manufacturing facility remote from the site of the culvert that needs to be repaired before being transported. The manufactured composite culvert liners of the invention are economical, durable, and corrosion resistant.

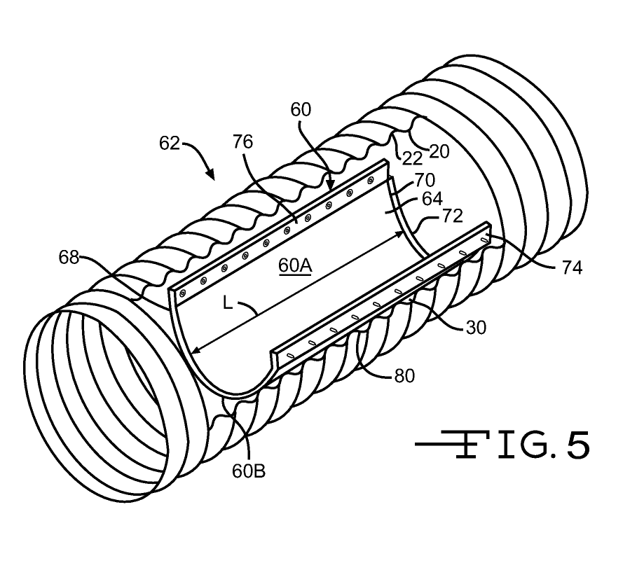

Referring now to FIG. 5, a second embodiment of the culvert liner is shown at 60. The culvert liner 60 includes a body 64 having a substantially semi-cylindrical shape, an inside surface or flow face 60A, an outside surface 60B, a first axial end 68, a second axial end 70 opposite the first end, a first axially extending edge area 74, a second axially extending edge area 76, and a substantially uniform radius. In the illustrated embodiment, the first and second axially extending edge areas 74 and 76 define nailing flanges, through which fasteners, such as nails, will be driven or inserted.

An underbite flange 72 may extend longitudinally outward of the second end 70 (to the right when viewing FIG. 5). Alternatively, although not illustrated in FIG. 5, angled, axially extending transition areas, such as the transition areas 28 described above, may be formed between the first and second axially extending edge areas 74 and 76 and the semi-cylindrical body 64. These transition areas may increase the annular space 30 defined between the inside surface of the culvert 12 and the outside surface 60B of the culvert liner 60. The increased annular space increases the space available for grout 36, and can prevent the outside surface 60B of the culvert liner 60 from contacting the nuts 16 or the bolts that may extend outward of the nuts 16.

As shown in FIG. 5, a second embodiment of the culvert is shown at 62. The culvert 62 is substantially similar to the culvert 12, but has no bolts or nuts 16 extending from the inside surface 62A of the culvert 62. Thus, the outside surface 60B of the culvert liner 60 makes substantially consistent contact with the ridges 20 along the length L of the culvert liner 60. The annular space 80 to be filled with grout 36 is thus limited to the space between the furrows 22 and the outside surface 60B of the culvert liner 60.

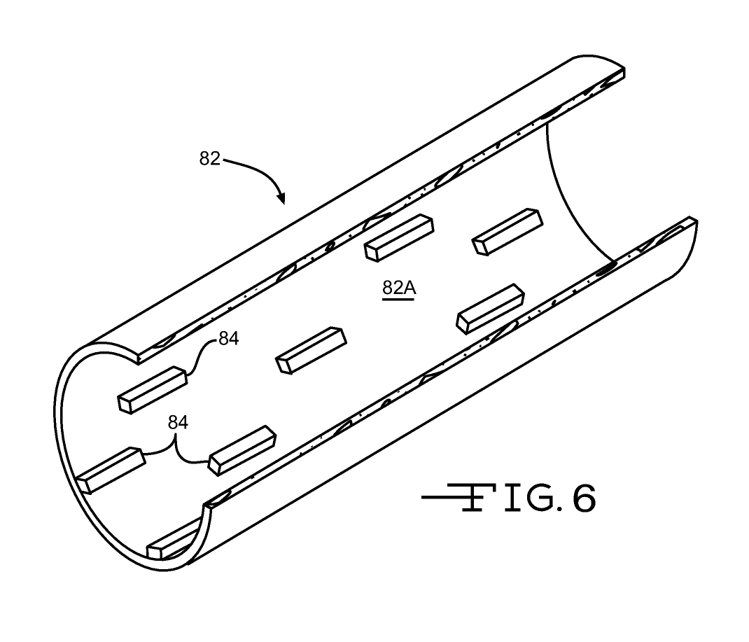

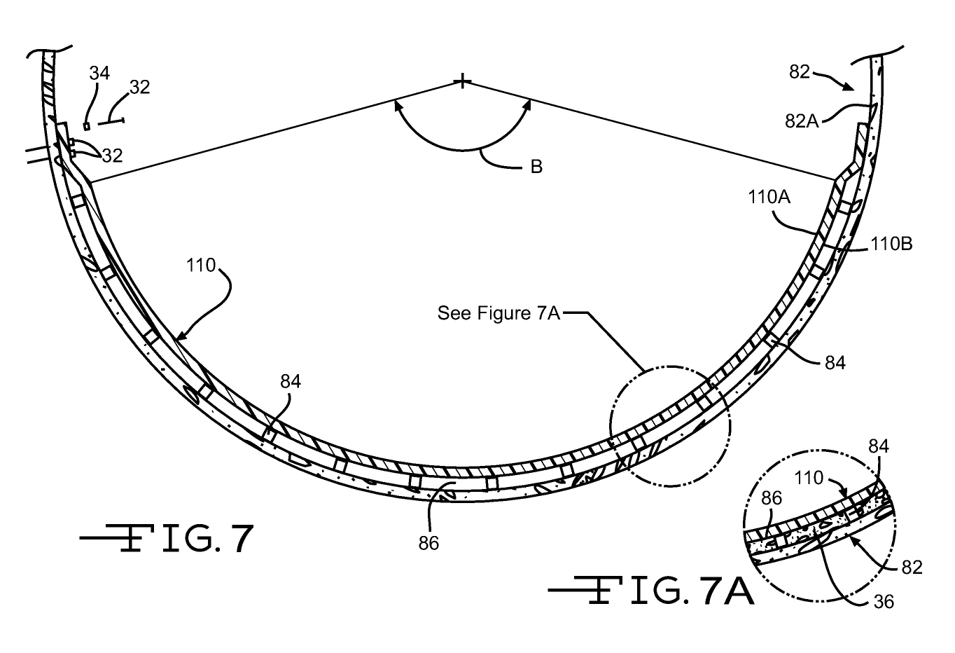

Referring now to FIGS. 6 and 7, a third embodiment of the culvert is shown at 82, and a third embodiment of the culvert liner is shown at 110. The culvert 82 has a substantially smooth inside surface 82A. To create an annular space 86 for grout 36 between the inside surface 82A and the outside surface 110B of the culvert liner 110, longitudinally extending spacing members or furring strips 84 may attached to the inside surface 82A of the culvert 82. The outside surface 110B of the culvert liner 110 may then be positioned against the furring strips 84 to create the annular space 86. The furring strips may be formed from any desired material, such as high density foam, wood, and plastic. The furring strips 84 may be attached to the inside surface 82A of the culvert 82 by any desired means, such as with mechanical fasteners, and adhesive. The furring strips 84 need only have the minimum height or thickness necessary to form the annualar space 86, and to avoid reducing the fluid flow capacity of the culvert 82. For example, each furring strip 84 may have a height of about 1.0 inch. Alternatively, each furring strip 84 may have a height within the range of from about 0.5 inches to about 1.5 inches. Additionally, each furring strip 84 may have a height within the range of from about 0.25 inches to about 2.0 inches.

The furring strips 84 may be arranged circumferentially on the inside surface 82A and spaced about 40 inches apart. Alternatively, the furring strips 84 may be spaced within the range of from about 36.0 inches to about 50.0 inches apart. Additionally, the furring strips 84 may be spaced within the range of from about 24.0 inches to about 60.0 inches apart. In the illustrated embodiment, the furring strips 84 are formed having a length of about 1.0 feet and are arranged longitudinally with about 4.0 feet between each strip 84. Alternatively, the furring strips 84 may have any other desired length, up to the length of the culvert 12 in which they are installed. The furring strips 84 may be left in place within the annualar space 86 after the annualar space 86 has been filled with grout 36.

If desired, the furring strips 84 may also be used to create increased annular space between the inside surface of the culvert 62 and the outside surface 60B of the culvert liner 60 shown in FIG. 5.

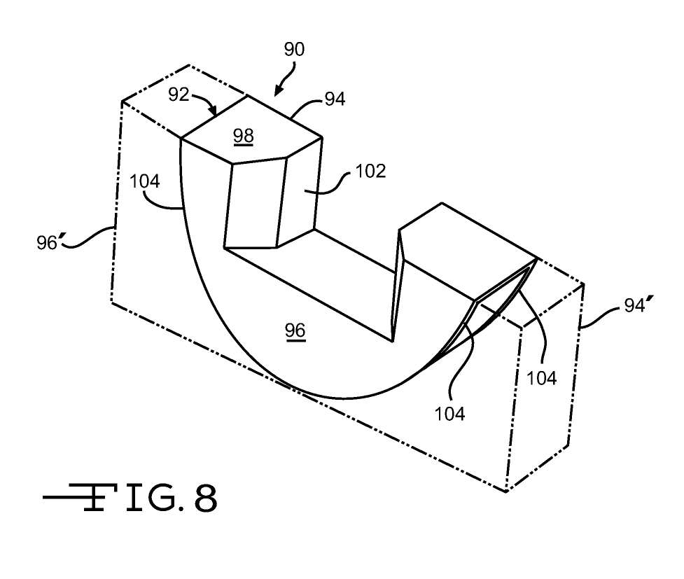

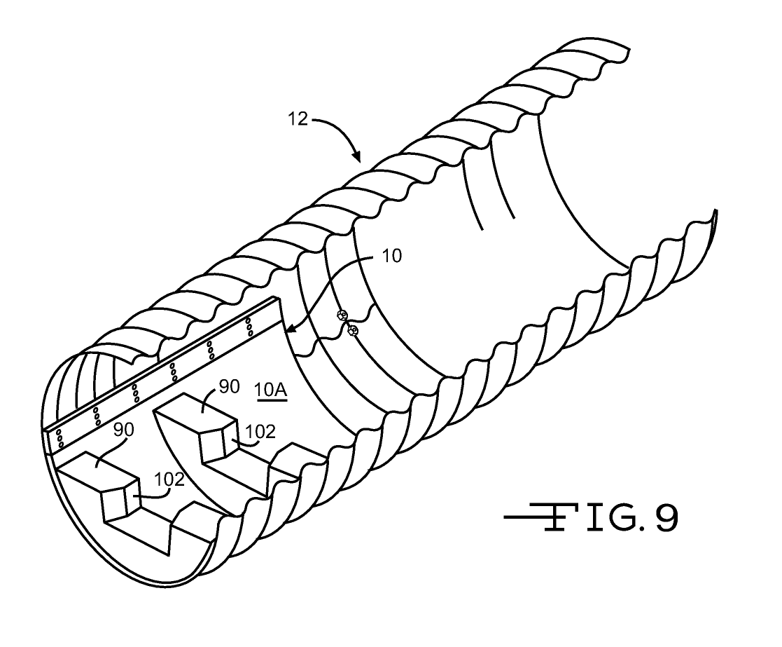

Referring now to FIGS. 8 and 9, the culvert liners of the invention may be enhanced by incorporating fish assist devices, such as the weir 90 with the culvert liners, such as the culvert liners 10. One or more fish weirs 90 may be mounted on the flow faces 10A of the culvert liners 10. The number of weirs 90 required will vary depending on the culvert slope and flow of fluid through the culvert 12. The weirs 90 may be formed of the same abrasion resistant composite material used to form the culvert liner 10 described above.

The illustrated weir 90 includes a body 92 formed as a composite panel as described above. The body 92 has upstream and downstream facing walls 94 and 96, respectively, and an upwardly facing wall 98. The walls 94, 96, and 98 define an opening 102 through which fish may swim.

The walls 94 and 96 may be initially formed having a substantially rectangular shape, as shown by the phantom lines 94′ and 96′. The walls 94′ and 96′ may be custom cut at any location, including in-situ, to define the walls 94 and 96, respectively, and to engage the flow faces 10A of the culvert liners 10. The walls 94 and 96 further define culvert engagement surfaces 104. The culvert engagement surfaces 104 of the weirs 90 may be bonded to the culvert liners 10 at the repair site. The weirs 90 may be bonded to the culvert liners 10 by any desired means, including but not limited to, adhesives such as a methacrylate adhesive, and composite welding with glass reinforced resin. Alternatively, the weirs 90 may be integrally formed with the culvert liners.

The weirs 90 may be attached to the culvert liners 10 and positioned relative to each other such that the depth of fluid flowing through the culvert 12 will increase and the velocity of the fluid flowing through the culvert 12 will be slowed. The weirs 90 may also be positioned to complement or cooperate with other fish-pass devices, such as ladders or resting pools, that may be installed adjacent or in the culvert 12.

Alternatively, the height of the walls 94 and 96 may be adjustable to allow for each adjustable weir 90 to be installed at a different height. Other fish-pass devices, such as baffles, and other flow modifying structures may also be attached to, or integrally formed with, the culvert liner to provide an improved, fish-friendly swim zone for migrating fish.

The principle and mode of operation of the culvert liner and culvert liner system have been described in its preferred embodiment. However, it should be noted that the culvert liner and culvert liner system described herein may be practiced otherwise than as specifically illustrated and described without departing from its scope.

What is claimed is:

1. A liner for repairing a culvert, the liner comprising a substantially semi-cylindrical body having an inside surface and an outside surface, the liner being configured for attachment to an inside surface of a culvert and having a shape corresponding to the inside surface of the culvert.

2. The liner according to claim 1, further including an axially extending edge area defining a nailing flange.

3. The liner according to claim 2, further including an angled, axially extending transition area formed between the nailing flange and the substantially semi-cylindrical body.

4. The liner according to claim 1, further including a fish weir mounted on the inside surface of the liner.

5. The liner according to claim 1, further including a fish weir integrally formed with the liner and extending from the inside surface of the liner.

6. The liner according to claim 1, wherein the liner is formed as a composite panel having a plurality of fiber layers in a resin matrix.

7. The liner according to claim 6, wherein the liner includes a layer of parallel fibers oriented substantially in a hoop direction of the liner.

8. The liner according to claim 6, wherein the liner includes an abrasion layer, the abrasion layer comprising a glass fiber mat impregnated in a resin matrix and defining the inside surface of the liner.

9. The liner according to claim 6, wherein aggregate material is bonded to the outside surface of the culvert liner.

10. A culvert liner system for repairing a culvert comprising:
a culvert liner mounted to an inside surface of a culvert and defining a semi-annular space between an outside surface of the culvert liner and the inside surface of the culvert; and
a layer of grout disposed within the semi-annular space.

11. The culvert liner system according to claim 10, wherein the culvert liner further includes a substantially semi-cylindrical body having an inside surface and an outside surface, the liner being configured for attachment to an inside surface of a culvert and having a shape corresponding to the inside surface of the culvert.

12. The culvert liner system according to claim 11, wherein the culvert liner further includes an axially extending edge area defining a nailing flange.

13. The culvert liner system according to claim 12, wherein the culvert liner further includes an angled, axially extending transition area formed between the nailing flange and the substantially semi-cylindrical body.

14. The culvert liner system according to claim 10, further including a fish weir mounted on the inside surface of the culvert liner.

15. The culvert liner system according to claim 10, further including a fish weir integrally formed with the culvert liner and extending from the inside surface of the culvert liner.

16. The culvert liner system according to claim 10, wherein the culvert liner is formed as a composite panel having a plurality of fiber layers in a resin matrix.

17. The culvert liner system according to claim 16, wherein the culvert liner includes a layer of parallel fibers oriented substantially in a hoop direction of the liner.

18. The culvert liner system according to claim 16, wherein the culvert liner includes an abrasion layer, the abrasion layer comprising a glass fiber mat impregnated in a resin matrix and defining the inside surface of the liner.

19. The culvert liner system according to claim 10, wherein aggregate material is bonded to the outside surface of the culvert liner.

20. The culvert liner system according to claim 10, further including a plurality of spacing members between the outside surface of the culvert liner and the inside surface of the culvert.

21. A method of repairing a culvert comprising the steps of:
positioning a culvert liner within a culvert such that the culvert liner is spaced apart from the culvert to define a semi-annular space between an outside surface of the culvert liner and the inside surface of the culvert;
attaching a portion of the culvert liner to the culvert with fasteners; and
filling the semi-annular space with grout.

22. The method according to claim 21, wherein the culvert liner includes an axially extending edge area defining a nailing flange, and wherein the step of attaching a portion of the culvert liner to the culvert includes inserting the fasteners through the nailing flange.

23. The method according to claim 21, further including attaching a plurality of spacing members between the outside surface of the culvert liner and the inside surface of the culvert prior to filling the semi-annular space with grout.

24. The method according to claim 21, further including attaching a fish weir to an inside surface of the culvert liner.

25. The method according to claim 21, further including integrally forming a fish weir with the culvert liner, the fish weir extending from the inside surface of the culvert liner.
